(19) United States
(12) Patent Application Publication
(10) Pub. No.: US 2023/0010140 A1
(43) Pub. Date: Jan. 12, 2023

(54) SYSTEM AND METHOD FOR A SOCIAL NETWORKS PAYMENT ACCEPTANCE PROCESSING SYSTEM USING BIOMETRICS, ENCRYPTION, AND TOKENIZATION TO SECURELY STORE INFORMATION

(71) Applicant: REIMAGINATION TECHNOLOGIES, INC., LOS ANGELES, CA (US)

(72) Inventors: Jaime-Federico Gonzalez-Gasque, LOS ANGELES, CA (US); Alberto Gonzalez, LOS ANGELES, CA (US); Julian Gonzalez-Friederich, LOS ANGELES, CA (US); Magdalena Monsivais-Rodriguez, LOS ANGELES, CA (US); Luis-Eduardo Gonzalez-Balam, LOS ANGELES, CA (US)

(21) Appl. No.: 17/410,405

(22) Filed: Aug. 24, 2021

Related U.S. Application Data
(60) Provisional application No. 63/220,877, filed on Jul. 12, 2021.

(51) Int. Cl. G06Q 20/32; G06F 21/32; G06Q 50/00

(52) U.S. Cl. CPC G06Q 20/3272; G06F 21/32; G06Q 20/3255; G06Q 50/01; G06Q 20/4012

(57) ABSTRACT

A social media based online payment system that allows a customer to use his/her voice to make a payment. Once the cardholder voice is enrolled into the bank's APP or the first payment is made via the social media application—such as the WhatsApp® messaging application or the Facebook® Messenger application, all future payments can be made with a simple voice command, secured through biometric voice authentication. The customer does not need to share sensitive credit/debit card information every time he/she makes a payment. The system tokenizes and encrypts the card information, and also registers the customer's voice fingerprint. The customer can make future payments to any affiliated merchant with a voice command, as simple as sending a voice message through the social media application. Businesses can send payment requests to their customers through social media messages. The customer may attend to the merchant's messages whenever he/she wishes, without jeopardizing financial safety and without receiving annoying phone calls for payments.

### CROSS-REFERENCE TO RELATED APPLICATION

This application claims the priority benefit under 35 U.S.C. § 119(e) of U.S. Provisional Application No. 63/220,877 filed on Jul. 12, 2021, the disclosure of which is incorporated herein by reference in its entirety.

### TECHNICAL FIELD

This disclosure relates generally to electronic payments, and more specifically to a software-based service that accepts credit and debit card payments in social networks by allowing the cardholder to make the payments through a simple voice command in cardholder's own voice, which is biometrically authenticated to provide a secure payment process.

### BACKGROUND

Electronic payments have dramatically evolved over the years. For example, the credit/debit card payment acceptance machines at point-of-sale (POS) locations (such as a cash register at a supermarket) and the e-commerce website based payment systems allowing a credit/debit cardholder to enter the card number and the Card Verification Value (CVV) code on the back of the card on the website to make the electronic payments are still generally widely-used. However, other POS payment acceptance systems, such as, for example, the Europay Mastercard and Visa (EMV) terminals, Near-Field Communication (NFC) units allowing payment through a simple touch of the corresponding chip-enabled credit/debit card, and mobile card readers are also becoming increasingly popular. Additionally, apps have been designed to allow cardholders to use their mobile devices to effectuate payments through a simple scan of a Quick Response (QR) code (or other one-dimensional or two-dimensional (2D) barcodes) or their face using face recognition technologies.

Telephone based payments are also routinely used to pay bill collectors, utility companies, travel agencies, medical service providers, remote merchants, and so on. One of the top challenges for travel agencies, insurance companies, subscription services, merchants offering telemarketing sales promotions, Mail Order (MO) or Telephone Order (TO) companies, and the like, is their dependence on payment collections by telephone, which is a non-face-to-face means of collecting payments. However, such payments do not come without attendant risks. For example, today, millions of collection calls are made by call centers around the world. Some of these calls may be fraudulent, putting the security of cardholders at risk. When responding to such calls, the cardholders must disclose their confidential credit/debit card information—such as the card number, its expiration date, and card's CVV or security code—to the telephone operator to make the required payments. A malicious operator at the call center can use such critical cardholder information to make fraudulent purchases, thereby creating serious problems for the cardholder and the same merchants the call center is engaged to serve. The fraudulent transactions may translate into chargebacks (from the card issuers), with increased transactional risks and, consequently, a higher financial cost to the business.

PayLinks provide a partial solution to this problem. A PayLink may be an emailed link that the customer can click on to pay their bill online. Under the PayLink option, a radio button with “Pay My Invoice” text (or similar notation) may be displayed on the customer's device (smartphone, tablet, laptop computer, and the like). When the customer clicks that button, they may be presented with a screen where they can pay their invoice online with a debit or credit card. However, because such links may arise from a fraudulent source, they can result in potentially unsecured activities, which generate distrust and offer an unfriendly user experience.

With the advent and popularity of social media networks like Facebook®, Twitter®, and so on, the merchants are offering more and more options to social media users to make payments to the merchants online using a social media platform. However, currently, payments to merchants via social media forces the client to re-enter credit/debit card information each time they pay. This leaves the clients vulnerable each time they enter their personal and payment information online, especially in the event that the payment link or a QR code (for payment initiation) is not transmitted from a secure source.

### SUMMARY

This Summary provides a simplified form of concepts that are further described below in the Detailed Description. This Summary is not intended to identify key or essential features and should therefore not be used for determining or limiting the scope of the claimed subject matter.

As mentioned before, telephone calls from bill collectors or other merchants for payments may not provide the financial safety necessary for a customer's peace of mind. Furthermore, a customer may find multiple such calls harassing and privacy-invading. In case of online payments, although systems and apps have been devised to ensure customer's financial safety, the payment transactions conducted via social media platforms still remain exposed to fraud and unsecured activities.

It is therefore desirable to devise a method of online payment that allows a customer to use a social media platform to make a payment in a simple, secure, user-friendly, and trustworthy manner. It is further desirable to effectuate the payment through social media messaging instead of disturbing telephone calls, without jeopardizing the customer's financial safety.

As a solution, particular embodiments of the present disclosure relate to a system and method for accepting credit and debit card payments in social networks via a social media application such as, for example, the WhatsApp® messaging application and the Facebook® Messenger application. The solution may operate as an intermediary between a customer and a merchant. This intermediary system may support payment acceptance and execution and may offer a social POS in social networks to allow merchants affiliated with Payment Service Providers (PSPs), aggregators, or card issuer banks to receive payments with a credit or debit card (for example, VISA®, MasterCard®, American Express®, and the like). The system allows businesses to send payment requests to their clients by means of messages through social networks and to receive payments safely through a simple voice command spoken by the client using a smartphone, a tablet, or a personal computer.

Initially, at the time of the first payment, the cardholder may capture/scan and store their credit/debit card information in a secure way. The system may tokenize and encrypt this information, and also register the individual cardholder's biometric voice fingerprint. By doing so, the cardholder is able to make future payments to any affiliated merchant with a simple voice command, as simple as sending a voice message through the social media application. The voice message may be a configurable phrase such as, for example, “I approve the payment with code 3 4 6 7.” In one embodiment, the code may be a variable number that is randomly-generated by either the intermediary system or the card issuer bank.

In certain embodiments, to avoid fraud, the intermediary system of social media-based payments fulfills payments through a telephone number from the merchant or card-issuer bank itself, which has already been verified by the WhatsApp® or Facebook® platform and which has a seal or mark that identifies it and authenticates it. This ensures the customer that the payment request is genuine and their payment will be sent to the actual merchant, and not to an impostor.

In one embodiment, the present disclosure is directed to a computer program product comprising a non-transitory computer-usable medium having computer-readable program code embodied therein, wherein the computer-readable program code, when executed by a computing system, causes the computing system to implement a method. The method comprises: (i) sending a payment notification from a merchant to a customer of the merchant via a text message having a format required by a social media messaging application, wherein the social media application is one of the following: a WhatsApp® messaging application, and a Facebook® Messenger application; (ii) offering the customer a choice to pay the merchant via the social media application using customer's voice along with a customer-selected means of payment; and (iii) processing a voice signature of the customer and the customer-selected means of payment to effectuate the payment to the merchant.

In another embodiment, the present disclosure is directed to a method, which comprises: (i) receiving, by a computing system, a payment notification from a merchant requesting a payment from a customer, wherein the payment notification identifies the customer and a phone number registered for the customer with a social media messaging application; (ii) sending, by the computing system, the payment notification to the phone number of the customer as a first text message having a format required by the social media application, wherein the first text message offers the customer an option to pay the merchant electronically via the social media application; (iii) determining, by the computing system, that the customer is registered for voice payment and has selected the option to pay the merchant; (iv) sending, by the computing system, a second text message to the customer in the format required by the social media application, wherein the second text message contains a pre-defined sentence; (v) instructing, by the computing system, the customer to speak and record the pre-defined sentence using the social media application; (vi) receiving, by the computing system, the following from the customer via the social media application: (a) an identification of a means of payment selected by the customer to electronically pay the merchant, and (b) an audio message containing a recording of the pre-defined sentence spoken by the customer; (vii) authenticating, by the computing system, a voice signature of the customer based on an electronic analysis of the audio message; and (viii) executing, by the computing system, a transaction with an entity that has issued the customer-selected means of payment to effectuate the payment to the merchant. In one embodiment, the pre-defined sentence may be generated by appending a variable number to a pre-designated command phrase. For example, in the earlier-mentioned sentence “I approve the payment with code 3 4 6 7”, the pre-designated command phrase is “I approve the payment” and the variable number is “3 4 6 7” (which may be randomly-generated).

In a further embodiment, the present disclosure is directed to a method, which comprises: (i) receiving, by a computing system, a payment notification from a merchant requesting a payment from a customer, wherein the payment notification identifies the customer and a phone number registered for the customer with a social media messaging application; (ii) sending, by the computing system, the payment notification to the phone number of the customer as a first text message having a format required by the social media application, wherein the first text message offers the customer an option to pay the merchant electronically via the social media application; (iii) determining, by the computing system, that the customer has selected the option to pay the merchant; (iv) sending, by the computing system, a second text message to the customer in the format required by the social media application, wherein the second text message contains a secure link to enable the customer to electronically make the payment to the merchant via the social media application, wherein the secure link allows the customer to provide details of a customer-selected means of payment for verification with an entity that has issued the customer-selected means of payment; (v) receiving, by the computing system, the details of the customer-selected means of payment via the social media application; (vi) transmitting, by the computing system, the details of the customer-selected means of payment and an amount of the payment to the entity for processing; (vii) receiving, by the computing system, an indication from the entity that the payment is successfully processed using the customer-selected means of payment; (viii) sending, by the computing system, a third text message to the customer in the format required by the social media application, wherein the third text message invites the customer to register the means of payment and a voice signature of the customer for future transactions; (ix) receiving, by the computing system, an affirmative response to the third text message from the customer via the social media application; (x) securely storing, by the computing system, the details of the customer-selected means of payment for future use by the customer; and (xi) registering, by the computing system, the customer for voice payment upon successful storage of the voice signature of the customer based on a pre-determined number of recordings of a pre-defined sentence received from the customer via the social media application, wherein the pre-defined sentence is formed of a pre-designated command phrase and a variable number.

Thus, the payment mechanism using social media and with a voice command simplifies the processing of payments for the merchants, and avoids the use of POS hardware to process the payments. Once the first payment has been made via the social media application, all payments for subsequent purchases or other transactions can be made with a simple voice command, secured through biometric authentication. The customer does not need to share sensitive credit/debit card information every time he/she makes a payment. This increases trust and enhances a customer's purchasing experience. Furthermore, because a service provider or merchant is allowed to send payment notifications via social media messages, the cardholder/customer is saved from receiving multiple, annoying phone calls for payments. The customer may attend to the messages whenever he/she wishes, and without disturbing or jeopardizing the customer's financial safety.

### BRIEF DESCRIPTION OF THE DRAWINGS

A more complete understanding of the present disclosure may be obtained by reference to the following Detailed Description when taken in conjunction with the accompanying Drawings. For ease of discussion, the same reference numbers in different figures indicate similar or identical items.

FIG. 1 is an exemplary arrangement to implement voice payments in social networks as per particular embodiments of the present disclosure.

FIGS. 2A-2B show exemplary flowcharts depicting various steps that may be performed by a computing system as per particular embodiments of the present disclosure to facilitate voice payments in social networks as per teachings of the present disclosure.

FIG. 3 is an exemplary illustration of different software modules that comprise the VPP application as per particular embodiments of the present disclosure.

FIG. 4 depicts an exemplary flowchart of how the voice payment methodology may be implemented in social networks as per particular embodiments of the present disclosure.

FIG. 5 illustrates an example configuration of a computer system that can be used to implement the voice payment methodology described herein.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the teachings of the present disclosure. Furthermore, this disclosure provides various example implementations or embodiments, as described and as illustrated in the drawings. However, this disclosure is not limited to the implementations described and illustrated herein, but can extend to other implementations, as would be known or as would become known to those skilled in the art.

Reference throughout this specification to “one embodiment,” “particular embodiments,” “this implementation,” “some embodiments,” or other terms of similar import, means that a particular feature, structure, or characteristic described in connection with the embodiment is included in at least one embodiment or implementation of the present disclosure. Thus, the appearances of these phrases in various places throughout this specification are not necessarily all referring to the same implementation/embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “social media-based,” “pre-defined”, “customer-selected,” etc.) may be occasionally interchangeably used with its non-hyphenated version (e.g., “social media based,” “predefined”, “customer selected,” etc.), and a capitalized entry (e.g., “Customer System,” “Merchant Module,” “Voice Payment Processor,” etc.) may be interchangeably used with its non-capitalized version (e.g., “customer system,” “merchant module,” “voice payment processor,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. Similarly, a first entity is considered to be in “communication” with a second entity (or entities) when the first entity electrically sends and/or receives (whether through wireline and/or wireless means) information signals (whether containing address, data, or control information) to/from the second entity regardless of the type (analog or digital) of those signals. It is further noted that various figures shown and discussed herein are for illustrative purpose only, and are not drawn to scale.

The terms “first,” “second,” etc., as used herein, are used as labels for nouns that they precede, and do not imply any type of ordering (e.g., spatial, temporal, logical, etc.) unless explicitly defined as such. Furthermore, items or features appearing in different figures may be identified using the same reference numeral for ease of discussion. However, such identification does not imply that the commonly-referenced items/features are identical across all embodiments.

It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor.

The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism.

In the discussion herein, the terms “social media payment host,” “third party system”, “third party payment platform,” and “host system” may be used interchangeably merely for ease of description. Similarly, the terms “customer”, “client,” and “user” also may be used interchangeably, and so are the terms “bank system” and “payment service provider system”. Furthermore, it is noted that, in the discussion below, the WhatsApp® and the Facebook® Messenger applications are merely used as examples of social media applications suitable for voice payment as per teachings of the present disclosure. Thus, although the discussion is primarily focused on these social media applications for ease of description and for the sake of brevity, the teachings of the present disclosure remain equally applicable to other social media applications, networks, or platforms.

Generally, an operator of the social media payment host or any other computing system discussed herein, a merchant, or a payment service provider (PSP) each may be a human operator or a non-human entity (such as a for-profit corporation, a non-profit enterprise, a government agency, or any other commercial or non-commercial entity). A customer, on the other hand, is a human person whose own voice is used to make a payment as per teachings of the present disclosure. In particular embodiments, the social media payment host may be an independent entity not connected/related with the customer, the merchant, or the (card-issuer) bank/PSP, except for its provision of the voice payment services through social media networks as per the teachings of the present disclosure.

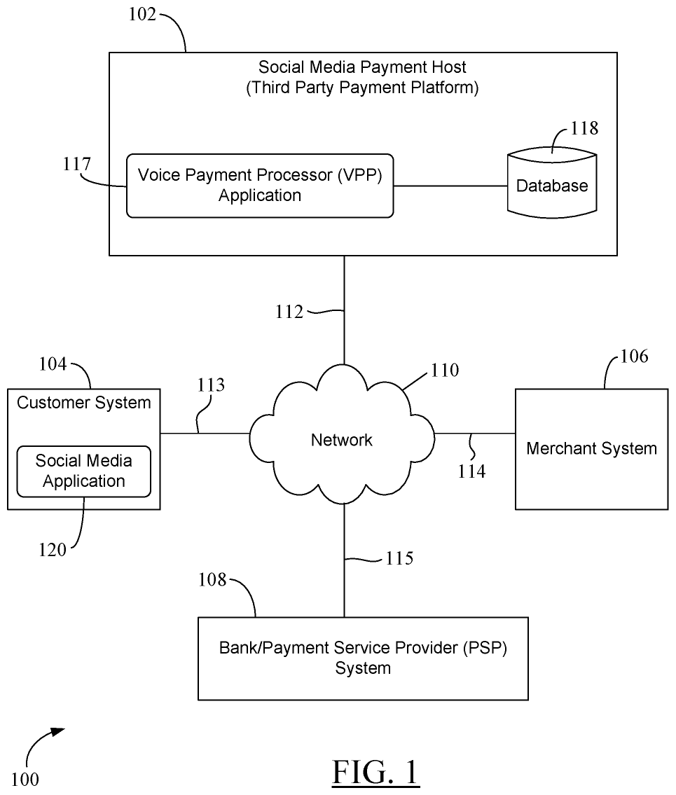

FIG. 1 is an exemplary arrangement 100 to implement voice payments in social networks as per particular embodiments of the present disclosure. In the arrangement 100 of FIG. 1, a social media payment host or third party payment platform (also interchangeably referred to as a host system or a third-party system) 102 is shown to be in communication with a customer system 104, a merchant system 106, and a bank or Payment Service Provider (PSP) system 108 via a communication network 110. In the embodiment of FIG. 1, each system 102, 104, 106, and 108 may be operable to communicate with any of the other system(s), as shown by the exemplary (bi-directional) links 112-115. However, in the context of the present disclosure, the third party system 102 may act as an “intermediary” between the customer system 104 and the merchant system 106, and communicate with the bank system 108 to facilitate customer's voice-based payments to the merchant as discussed in detail later. In a typical implementation, the communication network 110 may be an Internet Protocol (IP) network, such as the Internet. However, in other embodiments, the third party system 102 may individually communicate with one or more of the other systems 104, 106, 108 via different types of communication network(s) that support bi-directional communication. For example, the host system 102 may be connected to the bank system 108 via a corporate intranet or a specific communication platform made available to the host system 102, whereas the customer system 104 and the merchant system 106 may communicate with the host system 102 via the Internet. It is noted that the bi-directional links 112-115 are exemplary in nature; they do not imply that all types of communication between two entities connected by a link is bi-directional.

In the embodiment of FIG. 1, the customer system 104 may be associated with a customer or client of a merchant who is requesting a payment. The merchant system 106, on the other hand, may be associated with the merchant requesting the payment from the customer via a social media platform as discussed later. The bank or PSP system 108 may be associated with an acquiring bank who has issued a credit/debit card that the customer wishes to use to pay the merchant or with a PSP (such as PayPal, Stripe, Braintree, and the like). The acquiring bank—also referred to herein as the card-issuer bank—may have acquired licenses from respective credit/debit card companies (for example, VISA®, MasterCard®, American Express®, and the like) to offer their payment cards to customers. A PSP—also known as a merchant service provider—is a third party that helps merchants accept payments such as credit/debit card payments, bank transfers, real-time bank transfers, direct debit, and the like, by connecting the merchants to the broader financial world. The PSPs typically work with acquiring banks (payment processors) to manage the entire financial transaction from start to finish. Thus, although a bank and a PSP are two different entities, their systems are collectively represented in FIG. 1 using the reference numeral “108” for ease of discussion. It is understood that there may be multiple merchant systems, customer systems, and bank systems associated with the social media payment host 102. However, for ease of illustration and simplicity of discussion, only one of each such system 104, 106, 108 is shown connected to the network 110. The discussion below in the context of a single customer and a single merchant remains equally applicable to all merchants and customers utilizing the voice payment services of the third party system 102.

The host system 102 may be associated with a third party that merely provides an online platform (through the host system 102) to provide an independent, third party-based acceptance and execution of voice payments in social media networks, as discussed in more detail later below. In other words, as noted before, in particular embodiments, the payment host (managing the third party system 102) may be an independent entity that is neither affiliated nor associated with either the customer or the merchant or the bank/PSP, except to the extent of providing its online, social media-based voice payment service as per the teachings of the present disclosure. In particular embodiments, the third party host may charge a fee to the merchant or the bank/PSP for its voice payment services. In some embodiments, the third party host may license the voice payment software to the bank/PSP, in which case the functionality of the host system 102 may be incorporated into the bank system 108. Other arrangements to implement the voice payment features may be devised as suited in the marketplace.

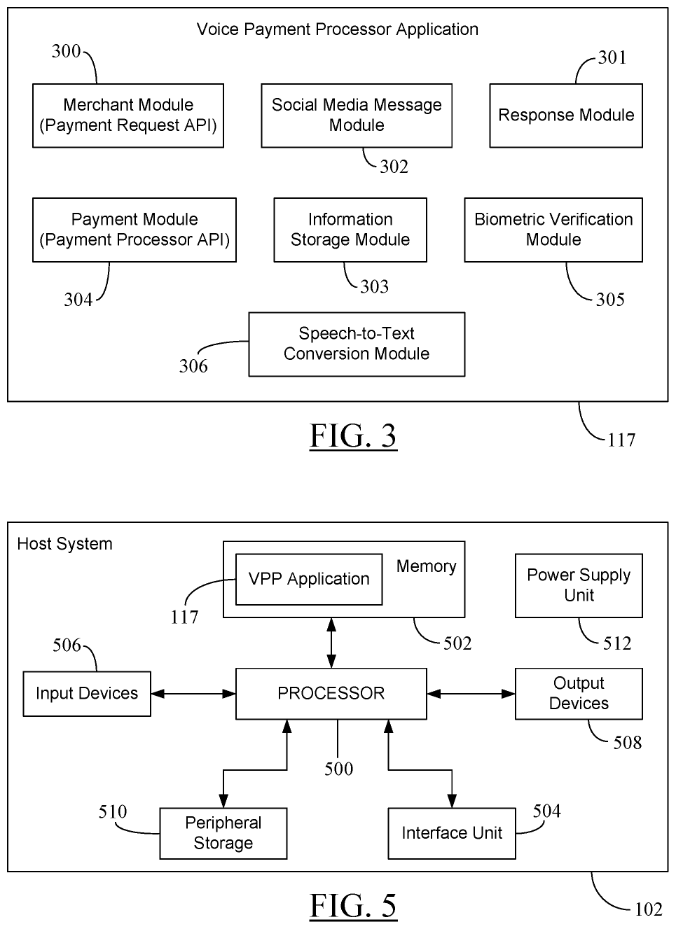

The third party system 102 may include a voice payment processor (VPP) application 117 (or, simply, a “payment application”), which may be a software module that implements the social media-based voice payment as per teachings of the present disclosure. Various software modules contained in the VPP application 117 are illustrated in the exemplary embodiment of FIG. 3 and discussed later below. In particular embodiments, the payment application 117 may be communicatively coupled to a database 118 in the third party's system 102. Various payment-related data such as, for example, billing notifications received from merchants, credit/debit card information received from customers, voice signatures of customers, payment authorizations received from banks/PSPs; one or more modules of the VPP application 117—including Application Programming Interfaces (APIs) to external programs or applications; and other relevant information necessary to implement the social media-based voice payment as per teachings of the present disclosure may be stored in the database 118. It is noted that, in some embodiments, the database 118 may be an integral part of the third party system 102 as shown, for example, in the embodiment of FIG. 1. In other embodiments, however, the database 118 may be an external data storage unit (for example, a cloud-based data storage) that is communicatively coupled to the third party system 102 for storage and retrieval of data. In certain embodiments, the database 118 may be implemented in software alone, or as a combination of hardware (for example, physical storage/memory) and software that manages the hardware (for example, a database management application). Additional architectural details of the third party system 102 are provided later with reference to discussion of FIG. 5.

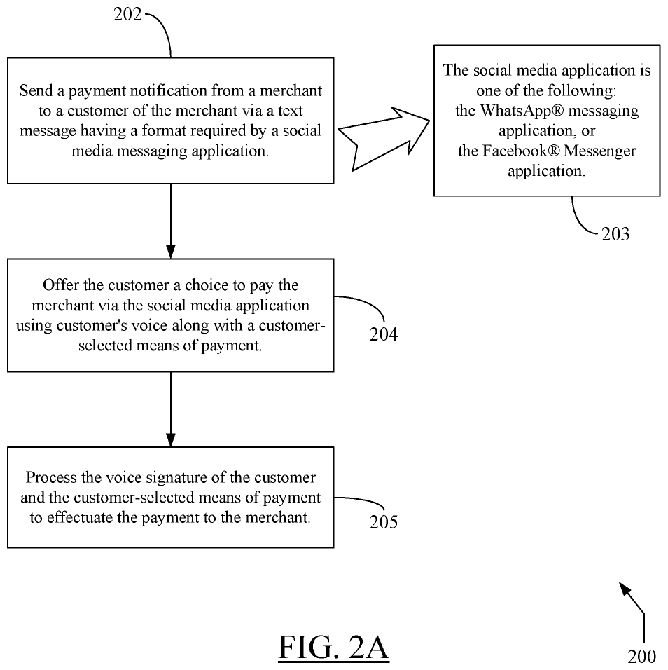

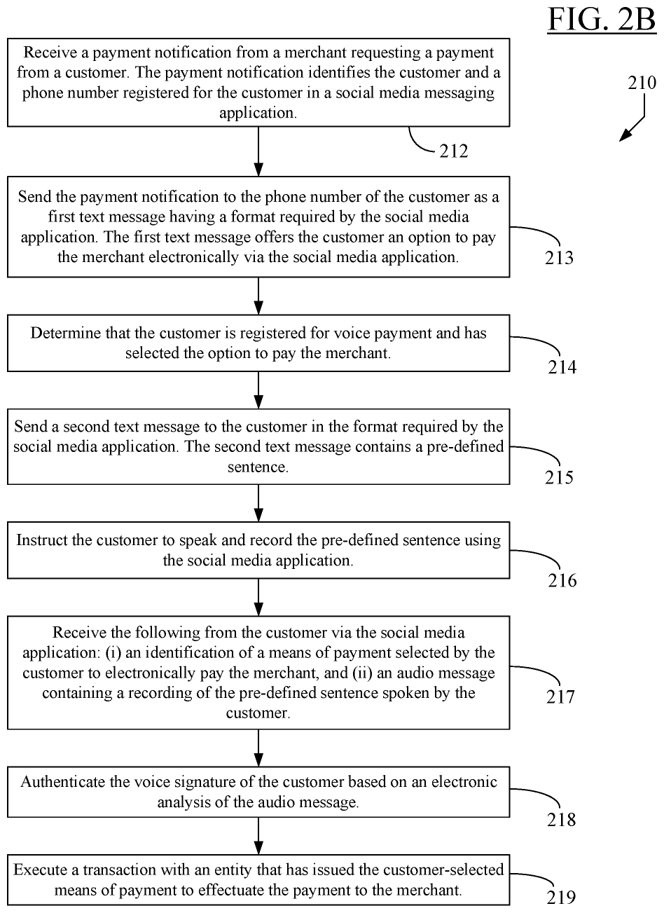

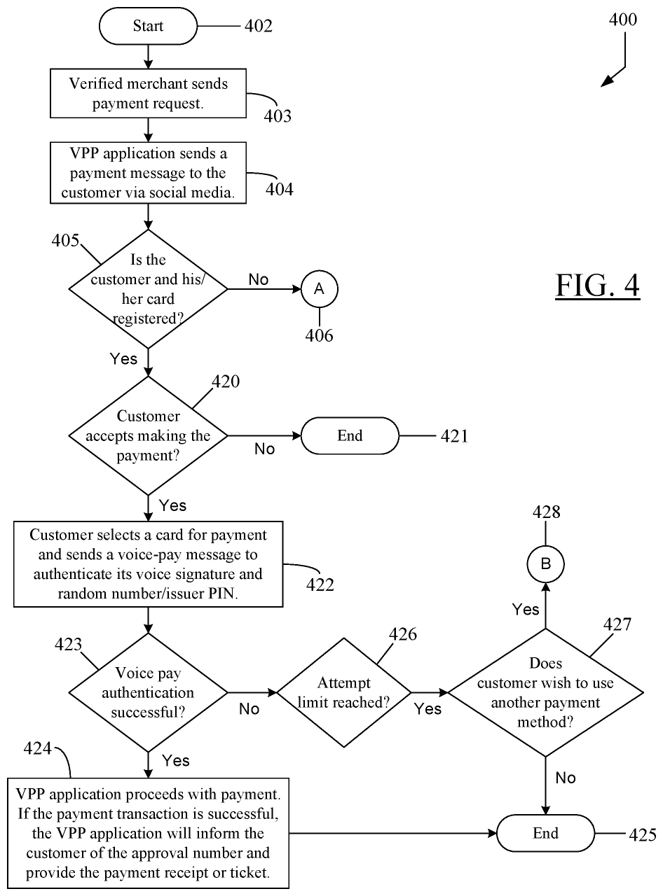

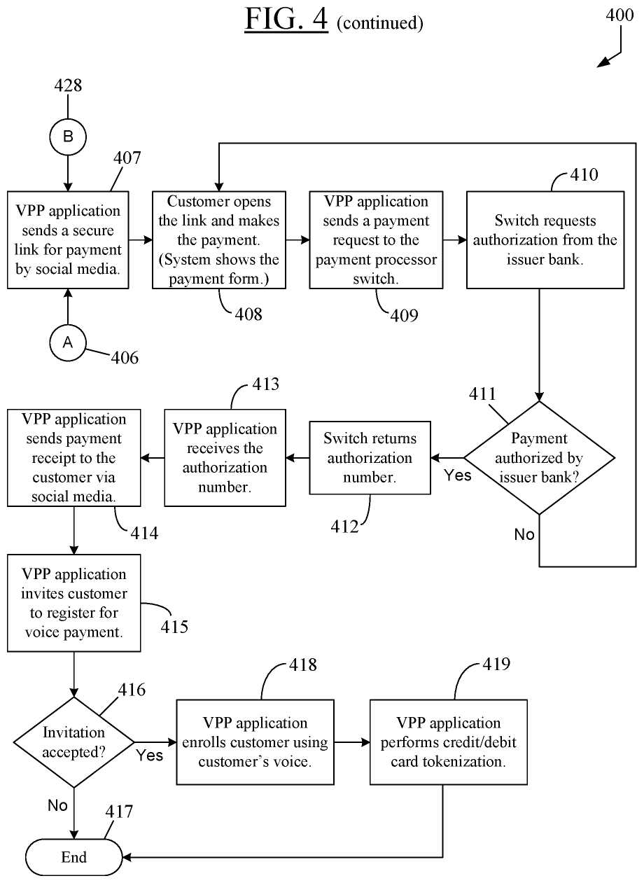

As noted above, the payment application 117 may be a software application comprising program code, which, upon execution by a processor (not shown) in the host system 102, enables the host system 102 to perform different operations to facilitate social media-based voice payments. An exemplary set of such operations is illustrated in FIGS. 2 and 4, which are discussed later below. More generally, the payment application 117, upon execution, may enable the host system 102 to receive, store, and analyze the content received at link 112 and also from other sources (such as, for example, from a user affiliated with the third party payment host, from an external website or data provider, and the like); responsively manage and process the content; and offer a social media-based service for payment acceptance and execution. In some embodiments, the host system 102 may function as a “server”, whereas each of the other systems 104, 106, 108 may function as a “client” of the host system 102. It is noted, however, that the client-server based arrangement is only one example of how the voice payment methodology of the present disclosure may be implemented. In some embodiments, the functionality of the payment application 117 may be implemented in a non-server system as well. The non-server system may be associated with an entity or system providing an online, social media-based voice payment facility to customers. Furthermore, in certain embodiments, the functionality of the payment application 117 may be implemented in an online cloud environment.

The program code constituting the payment application 117 may be stored in a storage unit or memory (not shown) in the host system 102. Such memory, processor, and other exemplary architectural details of the host system 102 are shown in FIG. 5 and discussed later below. In one embodiment, at least a portion of the program code for the payment application 117 may be based on Open Source Software (OSS). In some embodiments, the payment application 117 may be associated with one or more computing systems (not shown) managed by a server that coordinates content delivery to/from these computing systems to the systems 104, 106, 108. The architectural configuration, layout, appearance, or content of such a server based configuration are not relevant to the present disclosure and, hence, no additional details thereof are provided here. Similarly, additional architectural details of the systems 104, 106, and 108 are also not relevant to the present disclosure and, hence, are not shown in FIG. 1 for the sake of brevity and ease of illustration.

As shown in the embodiment of FIG. 1, the customer system 104 may include a social media application 120, the program code of which may be stored in a memory (not shown) of the system 104, and may be executed by a processor (not shown) in the system 104 under operative control of an Operating System (OS) of the customer system 104. In particular embodiments, the social media application 120 may be the WhatsApp® messaging application and/or the Facebook® Messenger application. The VPP application 117 may be configured to facilitate voice payments through one or more of these social media applications as per the teachings of the present disclosure. Additional or different social media application(s) 120 may be installed on the customer system 104 and, in some embodiments, the VPP application 117 also may facilitate voice payments through such applications.

In some embodiments, each of the systems 102, 104, 106, and 108 may be a computing system. A computing system generally processes, compiles, stores, and/or communicates information or data for business, personal, or other purposes thereby allowing users or operators of the system to take advantage of the value of the information. Because technology and information handling needs and requirements vary between different users or applications, computing systems may also vary regarding what information is handled, how the information is handled, how much information is processed, stored, or communicated, and how quickly and efficiently the information may be processed, stored, or communicated. The variations in computing systems allow for computing systems to be general or configured for a specific user or specific use such as financial transaction processing, airline reservations, enterprise data storage, or global communications. In addition, computing systems may include a variety of hardware and software components that may be configured to process, store, and communicate information and may include one or more computers, data storage systems, and networking systems.

Modern computing systems include many different types of consumer and commercial electronic devices such as, for example, personal computers (e.g., desktops or laptops), tablet computers, mobile devices (e.g., personal digital assistants (PDAs), User Equipments (UEs), or smart phones), corporate (or small business) server and data processing systems (e.g., blade server or rack server), a network storage device, and the like. These devices may vary in size, shape, performance, functionality, and price. In any event, almost all of these modern devices are equipped with relevant hardware and software to allow their users/operators to access a number of different websites over the Internet and perform online transactions.

For purpose of this disclosure, a computing system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for personal, business, scientific, control, or other purposes. The computing system may include random access memory (RAM), one or more processing resources such as a central processing unit (CPU) or hardware or software control logic, read-only memory (ROM), and/or other types of nonvolatile memory. Additional components of the computing system may include one or more disk drives, one or more network ports for communicating with external devices as well as various input and output (I/O) devices, such as a keyboard, a mouse, touch-screen and/or video display. The computing system may also include one or more buses operable to transmit communications between its various hardware components.

In particular embodiments, the VPP application 117 may be considered Software as a Service (SaaS) that works as a social POS in social networks. This service may be offered for free to customers, but the merchants and/or the banks/PSPs may be charged a fee for the use of the service. In one embodiment, the customer-specific functionality of the VPP application 117 may be offered as a downloadable mobile app and, upon execution, this mobile app may be seamlessly “integrated” or “incorporated” into the customer's social media application 120 through an API. The customer-specific functionality may allow a customer to send details of the customer's credit/debit card, recordings of customer's voice signature, and voice payment commands to the VPP application 117 as discussed later below. In some embodiments, a program shortcut may allow the customer to download the customer-specific software portion of the VPP application 117 into the customer system 104 for execution as an interface through the social media application 120 when making payments through the social media application 120. Similarly, the merchant-specific functionality of the VPP application 117 may be made available to the merchant system 106 via another API. The merchant-specific functionality may allow a merchant to send payment notifications to a customer via a social media channel and accept voice payments from the customer, as discussed in detail later below. It is noted here that the relevant program code of the VPP application 117 and/or an API may be stored in a memory (not shown) of the respective system 104, 106, and may be executed by a processor (not shown) in the respective system 104, 106 under operative control of a respective Operating System (OS). Similarly, the program code for the payment application 117 may be stored in a memory (not shown) in the host system 102 and executed by a processor (not shown) in the host system 102 under operative control of a corresponding OS (not shown) of the host system 102. In particular embodiments, the payment application 117 may configure the host system 102 to act as an intermediary between a customer and a merchant to facilitate social media-based voice payments from the customer to the merchant. In particular embodiments, the OS of each of the systems 102, 104, 106, and 108 may be a Microsoft® Windows® based operating system (such as, for example, Windows XP, Windows 7, 8, or 10, and Windows NT operating systems). In other embodiments, each system 102, 104, 106, and 108 may have a different operating system, which may not be a Microsoft® Windows® based operating system.

FIGS. 2A-2B show exemplary flowcharts 200, 210, respectively, depicting various steps that may be performed by a computing system as per particular embodiments of the present disclosure to facilitate voice payments in social networks as per teachings of the present disclosure. The computing system mentioned in the context of FIGS. 2A-2B may be the third-party system 102, which may include in hardware and/or software the functionality of the payment application 117 containing the software modules illustrated in the exemplary embodiment of FIG. 3 (discussed later). In one embodiment, the program code for the payment application 117 (and other relevant program code such as the program code for the OS of the computing system 102) may be executed by a processor (not shown) in the computing system 102 and, upon execution of the program code, the computing system 102 may be operative to perform the tasks illustrated in FIGS. 2A-2B (collectively “FIG. 2”). It is observed that the tasks 202-205 illustrated in the flowchart 200 provide an outline of the voice payment process, whereas the tasks 212-219 in the flowchart 210 provide more details of the voice payment process implemented as per teachings of the present disclosure.

In the flowcharts 200, 210, each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the processes shown in the flowcharts 200, 210. For discussion purpose, the processes in the flowcharts 200, 210 are described with reference to FIG. 1 as described above, although other models, frameworks, systems and environments may be used to implement these processes.

Referring now to FIG. 2A, initially, as noted at block 202, the computing system (for example, the host system 102 in FIG. 1) may send a payment notification from a merchant to a customer of the merchant via a text message having the format required by a social media messaging application. As noted at block 203, in one embodiment, the social media application may be the WhatsApp® messaging application or the Facebook® Messenger application. As discussed later, the payment notification may be received from the merchant system 106 and may be sent to the customer's system 104 as a WhatsApp® text message or a Facebook® Messenger text depending on the social media application 120—WhatsApp® or Facebook® Messenger—being used by the customer. As mentioned before, the customer may be a human person operating the customer system 104 on which the social media application is running. Thus, as noted at block 204, the computing system (here, the host system 102) may offer the customer a choice to pay the merchant via the social media application using customer's voice along with a customer-selected means of payment. In particular embodiments, such offer may be communicated to the customer via a WhatsApp®/Messenger text message. The customer-selected means of payment may include a debit or credit card selected by the customer to pay the merchant. Subsequently, at block 205, the computing system 102 may process the voice signature of the customer and the customer-selected means of payment to effectuate the payment to the merchant. As discussed later, such processing may include interactions with the bank that has issued the customer-selected credit/debit card and/or interactions with any PSP involved in the payment execution process. The voice signature of the customer may be received through the social media messaging application.

The flowchart 210 in FIG. 2B provides additional details of the voice payment process generally outlined in the flowchart 200 of FIG. 2A. Initially, as noted at block 212 in FIG. 2B, the computing system (here, the host system 102 in FIG. 1) may receive a payment notification from a merchant requesting a payment from a customer. The payment notification may identify the customer (for example, by name or customer account number held with the merchant) and a phone number registered for the customer in the social media messaging application (such as the application 120 in FIG. 1). The payment notification may be received from the merchant system 106 via the network 110. At block 213, the computing system may send the payment notification to the phone number of the customer as a first text message having the format required by the social media application. The first text message may offer the customer an option to pay the merchant electronically via the social media application. It is understood that, typically, the customer system 104 may be a mobile phone, User Equipment (UE), or smartphone, and may be associated with the customer's phone number used to open, establish, or register the customer's account with the social media application. Thus, the first text message may be sent as, for example, a WhatsApp® message to the customer's WhatsApp® account represented by the customer's phone number, and may be received by the customer at the customer system 104.

At block 214, the computing system 102 may determine that the customer is registered for voice payment and has selected the (first text message's) option to pay the merchant. The registration process for voice payment is discussed later with reference to FIG. 4. Consequently, at block 215, the computing system 102 may send a second text message to the customer in the format required by the social media application. The second text message may contain a pre-defined sentence. As mentioned earlier and discussed in more detail later with reference to FIG. 4, the pre-defined sentence may be, for example: “I approve the payment with code 3 4 6 7.” This sentence includes a pre-designated command phrase: “I approve the payment”, followed by a randomly-generated variable number “3 4 6 7”. Like the first text message, the second text message also may be sent as, for example, a WhatsApp® message to the customer's WhatsApp® account represented by the customer's phone number, and may be received by the customer at the customer system 104. At block 216, the computing system 102 may instruct the customer to speak and record the pre-defined sentence (specified in the second text message) using the social media application. In particular embodiment, the instructions to record the pre-defined sentence may be included as part of the second text message. The customer may use the hardware resources—such as a microphone—of the customer system 104 to generate a recording in the social media application.

At block 217, the computing system 102 may receive the following two items from the customer via the social media application: (i) an identification of the means of payment selected by the customer to electronically pay the merchant, and (ii) an audio message containing a recording of the pre-defined sentence spoken by the customer. For example, if the customer has a means of payment—for example, one or more credit and/or debit cards—already stored with the host system 102, the customer may identify and select the payment means to be used to pay the merchant, and provide a corresponding intimation to the host system 102 via a social media message from the customer system 104. In other embodiments, when only one method of payment is stored in the host system 102 on behalf of the customer, the reception of the audio message from the customer may automatically indicate to the host system 102 to select the pre-stored payment method for the customer. In this situation, a separate payment selection notification or message may not be received from the customer. The audio message may be received as a social media message such as, for example, a WhatsApp® audio message. In some embodiments, the audio message may be received as a Voice over IP (VoIP) communication over the network 110.

At block 218, the computing system 102 may authenticate the voice signature of the customer based on an electronic analysis of the audio message (received at block 217). Details of the storage of a customer's voice signature and registration of the customer for voice payment are discussed later with reference to FIG. 4. Thereafter, at block 219, the computing system 102 may execute a transaction with an entity—such as a bank associated with the system 108—that has issued the customer-selected means of payment to effectuate the payment to the merchant. Upon receiving an approval of the transaction from the entity, the computing system 102 may send the receipt of the payment via a social media message to the customer system 104.

It is noted that although a credit or debit card payment in a traditional currency (for example, US dollars, or other national currency) is primarily discussed herein, in certain embodiments, the customer may be allowed to make a payment in any one of the following forms or in a combination of two or more of the following forms: as a traditional currency, as a non-traditional monetary instrument (for example, fungible tokens like stablecoins), as a digital currency (for example, an Electronic Fund Transfer (EFT) payment, or a payment through an e-commerce payment processor like PayPal® or Zelle®), as a cryptocurrency (for example, Bitcoins or Ethers), and/or a non-fungible token (NFT).

FIG. 3 is an exemplary illustration of different software modules 300-306 that comprise the VPP application 117 as per particular embodiments of the present disclosure. The software modules 300-306 may be communicatively coupled with each other for exchange of data and other content therebetween to provide a seamless user experience to the users of the voice payment service. However, for ease of illustration, such interconnections among the modules 300-306 are not shown in FIG. 3. The merchant module 300 may receive payment notifications from a merchant. In one embodiment, the merchant module 300 may provide a payment request API to the merchant system 106 to enable a merchant to send payment notifications to the host system 102 via a secure web admin page at the host system 102. If the merchant is a debt collector, for example, the payment request API also may allow the merchant to load its collection files onto the host system 102 to initiate the payment activity against a customer via social media. A payment notification received from a merchant at the merchant module 300 may be a client-specific online payment request, an upload of the merchant's database of pending payments of clients, files associated with a collection campaign (for example, when the merchant is a debt collector), an online payment request sent by the merchant's sales system in response to a customer's online purchase or other transaction with the merchant's system 106, and so on.

It is noted that WhatsApp® messaging is used merely as an example in the below discussion of FIGS. 3-4. It is understood that the discussion remains applicable to other social media messaging applications—such as, for example, the Facebook® Messenger application—as well. However, for the sake of brevity and ease of description, all such social media applications are neither mentioned nor discussed in any appreciable detail below. Similarly, although a voice-based payment process in social networks is discussed herein, it is understood that human voice is used merely as an example of a biological feature or characteristics that may be selected for biometric verification. Other biometrics—such as, for example, a customer's fingerprint or palm print, face, or iris scan—also may be used along with or in place of human voice so long as the underlying social media messaging application supports exchange of data related to the selected biological feature/characteristics in the application-specific messaging format for ease of communication by the customer and verification/authentication by the payment application 117.

In FIG. 3, the response module 301 may contain decision logic to determine what decision to make regarding the responses received by various modules of the VPP application 117. For example, the response module 301 may determine whether a customer is registered for voice payment or not, or whether a customer has registered a specific means of payment (such as a credit/debit card) for future payments, and, based on the decision, may interact with other module(s) in the payment application 117 for the next course of action. The social media message module 302 may generate and send various text messages to the customer in a format required by the relevant social media application. For example, the social media message module 302 may send a payment notification received from a merchant or a payment receipt obtained from a bank to a customer in the form of a corresponding WhatsApp® text message. In one embodiment, the social media module 302 may generate notifications and payment receipts in the format of a WhatsApp® text message if such notifications or receipts are not already in the desired social media message format. Similarly, the social media module 302 also may receive WhatsApp® messages/responses from the customer—such as, for example, WhatsApp® audio messages containing voice samples of the customer, and may interact with other module(s) in the payment application 117 to process the contents of the received messages. The information storage module 303 may communicate with the database 118 (FIG. 1) to securely store and retrieve relevant data and information. For example, the information storage module 303 may store into the database 118 details of a customer's credit/debit card and audio files containing electronic voice samples of the customer, and may retrieve this information at the time of a voice payment transaction by the customer. The storage module 303 also may secure the credit/debit card information with encryption and tokenization before sending it to the database 118.

The payment module 304 may allow connectivity with the bank system 108 or any other payment processor system (not shown). For example, the payment module 304 may offer payment processor APIs to enable the host system 102 to communicate with payment processors, aggregators, card-issuer banks, and/or payment gateways (or switches). In particular embodiments, the payment module 304 may send a customer's payment information to a switch (or payment gateway), receive a payment authorization number from the switch, generate a payment receipt based on the payment authorization, and send the payment receipt to the social media message module 302 for sending the receipt to the customer as a WhatsApp® text message. The biometric verification module 305 may perform biometric voice enrollment, update, and verification. For example, the biometric module 305 may analyze the audio files of voice samples of a customer to extract the customer's voice signature therefrom, securely store the voice signature (for example, in the database 118 with the help of the storage module 303), and verify the voice signature every time the customer initiate a voice payment transaction.

The speech-to-text (STT) conversion module 306 may perform speech to text conversion for verification of at least the security code received in a WhatsApp® audio message from the customer. As mentioned before, at the time of voice payment, the customer may speak and record a pre-defined sentence and send the recording to the host system 102 as a WhatsApp® audio message. As per the earlier example, the pre-defined sentence may be: “I approve the payment with code 3 4 6 7”, which is formed of a pre-designated command phrase (“I approve the payment”) followed by a randomly-generated variable number or security code (“3 4 6 7”). In certain embodiments, the STT conversion module 306 may perform the speech-to-text conversion on the recording of the pre-defined sentence contained in the audio message to generate texts of the pre-designated command phrase and the variable number spoken by the customer. Thereafter, the STT conversion module 306 may verify that the customer-spoken text of the variable number (or security code) is correct. In some embodiments, the STT conversion module 306 also may verify that the customer-spoken text of the pre-designated command phrase is correct as well to maintain a record that the customer indeed approved the payment transaction and not any other type of transaction. This record-keeping may assist the merchant or other entity in the event a dispute arises as to whether the payment was authorized or not.

FIG. 4 depicts an exemplary flowchart 400 of how the voice payment methodology may be implemented in social networks as per particular embodiments of the present disclosure. In certain embodiments, at least the tasks 404-405, 407, 409, 413-421, and 423-427 may be performed by the host system 102 to facilitate voice payments in social networks as per teachings of the present disclosure. In one embodiment, the program code for the payment application 117 (and other relevant program code such as the program code for the OS of the host system 102) may be executed by a processor (not shown) in the host system 102 and, upon execution of the program code, the host system 102 may be operative to perform these tasks, which can be implemented in hardware, software, or a combination thereof. In the context of software, each task-specific block in the flowchart 400 may represent computer-executable instructions that, when executed by one or more processors, cause the processors to perform the recited tasks. The order in which the blocks are described is not intended to be construed as a limitation, and any number of the described tasks can be combined in any order and/or in parallel to implement the process shown in the flowchart 400. For discussion purpose, the process in the flowchart 400 is described with reference to the system configuration of FIG. 1 as described above, although other models, frameworks, systems and environments may be used to implement this process.

In the context of FIG. 3, it is noted here that, in some embodiments, the merchant module 300 may perform one or more tasks at block 403 in FIG. 4; the response module 301 may perform one or more tasks at blocks 405, 416, 420, 424, and 426-427 in FIG. 4; the social media message module 302 may perform one or more tasks at blocks 404, 407-408, 414-415, and 424 in FIG. 4; the information storage module 303 may perform one or more tasks at blocks 405, 415, 418-419, and 422 in FIG. 4; the payment module 304 may perform one or more tasks at blocks 408-409, 413-414, and 424 in FIG. 4; the biometric verification module 305 may perform one or more tasks at blocks 422-423 and 426 in FIG. 4; and the STT conversion module 306 may perform one or more tasks at blocks 422-423 in FIG. 4.

Referring now to FIG. 4, at blocks 402-403, a verified merchant may send a payment request or payment notification to the host system 102. The voice payment functionality of the VPP application 117 may be offered to payment processors, aggregators, or card issuer banks who accept payments by credit or debit cards and provide settlement of payments on behalf of their affiliated merchants through the direct deposit to the merchant's bank account once the payments have been authorized by the issuer banks and processed by the clearing houses. In one embodiment, the payment request at block 403 may be received at the host system 102 from a telephone number of the merchant or the issuer bank with which the merchant is affiliated. The telephone number may have been registered with the social media application (for example, WhatsApp® or Facebook® Messenger) and, hence, already may have been verified by the corresponding social media platform. In that case, the payment notification may contain a social media application-specific mark or seal that identifies the number and authenticates it as a valid number of the merchant and not of any fraudulent source. Thus, the merchant may be authenticated by the social media channel as well as by the merchant's bank (card issuer bank) or PSP. In another embodiment, the payment notification may be a text message having the format required by the social media application such as, for example, a WhatsApp® text message. The payment notification from the merchant may identify one or more customers from which the merchant is requesting payments and the phone numbers of those customers registered with the social media application.

Once the VPP application 117 receives the payment request, it may send a message to the customer system 104 at block 404 via WhatsApp® (or Facebook® Messenger). The message may be sent to the phone number of the customer registered with the social media application and may offer the customer an option to pay the merchant electronically via the relevant social media application (here, WhatsApp®). In one embodiment, the message may be sent encrypted and authenticated as coming from a trusted source. In another embodiment, the message may contain the phone number of the merchant registered with the social media application and also may contain the above-mentioned social media-specific mark, verified icon, or seal associated with the merchant, providing an assurance to the customer that the payment request is from an authentic source. As an example, the host system 102 may send the following WhatsApp® message on behalf of a telephone company collecting a bill from a customer: “Dear John Smith, the balance of your telephone bill for $250.64 on the account ending in 6321 is due now. Would you like to make your payment through Bank X's voice-pay service?” In this message, the Bank X may be the bank with which the telephone company is affiliated and that accepts payments on behalf of its affiliated merchant—here, the telephone company. The WhatsApp® message to the customer also may include the payment options “Yes” or “No” for the customer to choose.

At the decision block 405, the payment application 117 may determine if the customer is registered for voice payments and if the customer has a credit or debit card registered with the payment application 117. If this is the customer's first social media-based payment transaction (for the present merchant or any other merchant) using the payment application 117 or if the customer has declined to register for voice payments in the past (for the present merchant or any other merchant), the customer may not have been registered for voice payment yet. In that case, the payment application 117 may proceed to transition block 406 (identified by the circled letter “A” in FIG. 4) to initiate registration of the customer for voice payment. On the other hand, if the payment application 117 determines that the customer is indeed registered for voice payments, but declines at block 420 to make the payment at issue here (by selecting the “No” option in the WhatsApp® message at block 404), the social media-based payment process using the application 117 may terminate at block 421.

The transition block 406 leads to the voice payment registration process illustrated through blocks 407-419 in FIG. 4. Assuming that the payment application 117 determines at block 405 that the customer is not registered for voice payments, the payment application 117 may send a WhatsApp® text message at block 407 to the customer system 104 containing a secure link to enable the customer to electronically make the payment to the present merchant (or any other merchant whose payment request triggers the voice payment registration process) via the social media application (here, WhatsApp®). As an example, the WhatsApp® message at block 407 may read: “Please click on the following secure link https://www.xyz.com/payusd?token=tk-10334 to make your payment.” The secure link may allow the customer to provide details of the customer's credit/debit card via WhatsApp® messaging for verification with the card-issuer bank. In particular embodiments, the secure link may be a Hypertext Transfer Protocol Secure (HTTPS) link, which the customer may click within its WhatsApp® message to make the payment. In particular embodiments, the information/data communicated between the host system 102 and the customer system 104 may be in the form of an Extensible Mark-up Language (XML) object. When the customer clicks on the link or opens the link (block 408), a payment form (not shown) may be displayed on a display screen of the customer system 104. The payment form may have various fields to capture details of the cardholder's card information. Such fields may include, for example, a field to enter the name of the customer, a field to enter the name of the cardholder (if different from the customer), a field to enter the number of the credit or debit card the cardholder wishes to use for the payment, a field to enter the expiration date of the card, a field for the CVV code of the card (if any), a field to enter the customer's (or cardholder's) e-mail, a field to enter the amount being paid, a field describing the payment (for example, telephone bill, medical invoice, and the like), and so on. In particular embodiments, the description of the payment and the amount to be paid may be pre-filled in the form and may not be changed by the customer. The customer may have the option of scanning details of his/her card into the relevant fields of the form if the customer system's 104 mobile browser supports such scanning. Otherwise, the customer may manually type the details into the form. The customer may then verify that the payment amount shown on the form is correct and that the card information entered in the form is complete. The customer may then click on the “Pay” radio button on the form to make the payment.

At block 409, the VPP application 117 may receive the details of the means of payment—credit or debit card—selected by the customer at block 408 via a corresponding WhatsApp® message, and may transmit the details of the customer-selected means of payment and the amount of payment to the card-issuer bank for processing. In particular embodiments, the VPP application 117 may send the transaction details to an intermediate payment processor switch or gateway (which may include a PSP), via APIs, for eventual approval by the issuer bank. In particular embodiments, the transaction details may be sent to the switch/PSP or issuer bank by a secure ISO 8583 communication channel. As noted at block 410, the payment processor switch and/or other intermediate processor—such as a PSP—may request the issuing bank for authorization of the payment and an approval code for the transaction. If the payment is not authorized by the issuer bank for whatever reason (for example, wrong card number, stolen card, expired card, insufficient funds, and the like), the VPP application 117 may send the rejection or error code—received from the issuer bank—to the customer via, for example, a new WhatsApp message and request the customer to re-initiate the payment process starting with the tasks at block 408, as indicated by the “No” outcome at decision block 411.

If the payment is authorized by the issuer bank—as indicated by the “Yes” outcome at decision block 411, the switch may return the authorization number received from the bank to the VPP application 117, as noted at blocks 412-413. The authorization or approval of the transaction by the issuer bank may not be in the format of the relevant social media application. In particular embodiments, the VPP application 117 may incorporate the contents of the payment receipt from the issuer bank into a WhatsApp® message and send the message to the customer, as noted at block 414. As an example, once the payment has been made, the host system 102 may report its approval and corresponding approval code number as the following WhatsApp® message: “Thank you. Your transaction dated Jun. 20, 2021 has been approved under code number 099600. Bank X Payment Services thanks you for your trust.” A similar text also may be sent by the VPP application 117 to the customer's WhatsApp® phone number as a Short Message Service (SMS) text message. In certain embodiments, the customer also may receive from the VPP application 117, via another WhatsApp® message, a foliated digital receipt in the PDF format as proof of the successful payment.

Once the payment process is completed, the VPP application 117 may send a WhatsApp® message to the customer system 104 inviting the customer to register the customer's credit/debit card for future payments and also to register the customer's voice signature for future payments (block 415). As an example, the WhatsApp® invitation message at block 415 may read: “Do you want to register your card and voice to make future payments?” The message also may contain clickable options labeled “Yes” and “No.” If the customer declines the invitation to register for voice payment, the process may terminate (blocks 416-417). However, if the customer agrees to register for voice payment at block 416, the VPP application 117 may enroll the customer for voice payment using customer's voice (block 418). The customer may be registered for voice payment upon successful storage of the customer's voice signature based on a pre-determined number of recording of a pre-defined sentence received from the customer via the social media application (here, WhatsApp®). In one embodiment, as a security request from the acquiring bank (card-issuer bank) or PSP, the voice enrollment process (discussed below) may be executed into the personal banking app of the bank or PSP, allowing the cardholder to pay by its voice (as discussed herein) to any collecting message sent by any affiliated merchant of the bank/PSP via social media. Once the cardholder voice is enrolled into the bank's app or the first payment is made via the social media application, all future payments can be made with a simple voice command as per the teachings of the present disclosure.

In one embodiment, as part of the enrollment at block 418, the VPP application 117 may send three (3) recording-related WhatsApp® text messages to the customer and receive and analyze the customer's response to each message as discussed herein. Each message may invite the customer to speak an identical voice command and send its recording to the host system 102 via the social media application. For example, the first of the three recording-related messages may read: “The voice registration process requires you to send three equal messages with the voice command given below. The voice command will be used to make your payments in future. Please, with your voice and pressing the WhatsApp® microphone icon, repeat the voice command: ‘I approve the payment with the code 3,4,6,7.’” The customer may record the voice command—“I approve the payment with the code 3,4,6,7”—and send a WhatsApp® voice message containing this recording to the host system 102. The VPP application 117 may biometrically analyze the received recording to extract the voiceprint or voice signature of the customer therefrom. The VPP application 117 also may securely store the extracted voice signature in, for example, the database 118 (FIG. 1). Thereafter, the VPP application 117 may send the second of the three recording-related messages to the customer. As an example, the second message may read: “Thank you. Please, with your voice and pressing the WhatsApp® microphone icon, repeat again: ‘I approve the payment, with the code 8,5,9,2.’” The customer may again record this voice command and send another WhatsApp voice message to the host system 102. The VPP application 117 may biometrically analyze this second recording to extract the customer's voice signature therefrom and may update the earlier-stored voice signature extracted from the first recording. Consequently, the VPP application may send the third of the three recording-related messages to the customer. As an example, the third message may read: “Thank you very much. To finish the registration process, please repeat again with your voice and pressing the WhatsApp® microphone icon: ‘I approve the payment with the code 1,9,5,0.’” The customer may record the voice command—“I approve the payment with the code 1,9,5,0”—third time and send another WhatsApp voice message to the host system 102. The VPP application 117 may biometrically analyze this third recording to extract the customer's voice signature therefrom and may update the earlier-stored voice signature extracted from the first and second recordings. Thereafter, the VPP application 117 may determine whether the biometric voice record is positive—that is, whether the voice signature of the customer is successfully extracted from the three recording samples received from the customer. If the biometric voice record is positive, the VPP application 117 may securely store the customer's voice signature for future payments and also may send a WhatsApp® text message to the customer. As an example, such message may read: “Successful registration. Bank X payment services thanks you for your trust.” On the other hand, in some embodiments, if the voice signature cannot be successfully extracted from the three recordings sent by the customer, the VPP application 117 may discard the earlier-stored voice signature and intimate the customer to re-initiate the recording process or abort it and resume it in future.

Additionally, as noted at block 419, before concluding the voice registration process (at block 417), the VPP application 117 also may perform tokenization of the customer's credit/debit card of record to securely store the details of the customer-selected means of payment for future use by the customer. The card information may have been received from the customer at block 408. In some embodiments, the customer may choose to register one or more additional cards even though the customer may have already provided card information for at least one card in the past. In one embodiment, the database 118 may be used for secure storage of customer-specific card details. In particular embodiments, the stored card information may comply with the data protection and security requirements of the Payment Card Industry—Data Security Standard (PCI-DSS) regulations developed by the PCI Security Standards Council (PCI SSC). Furthermore, proper encryption methods may be implemented to maintain security, integrity, and confidentiality of the customer's credit/debit card details transmitted over open public networks—such as the Internet. For example, the information transmitted in WhatsApp® or Facebook® Messenger messages may be end-to-end encrypted by the social media application itself. However, in some embodiments, the VPP application 117 itself may use tokenization and encryption to provide a secure payment facility to payment processors, banks, PSPs, switches, and the like, when they accept payments with the VPP application 117 (for example, via appropriate APIs as noted before) and when customers pay with their voice via their smartphones, tablets, and personal computers. The VPP application 117 may facilitate transactions that achieve the EMV Corporation (EMVCo) grade security, with cryptograms generated from variable credentials (tokens). The EMV specification information may be obtained from https://www.emvco.com.

Once the customer goes through the voice and card registration process of blocks 407-419—for example, during a social media-based payment to another merchant in the past—the payment application 117 may determine in the affirmative at decision block 405. Furthermore, if the customer selects the “Yes” option in the WhatsApp® message at block 404, the payment application 117 also may determine at decision block 420 that the customer has accepted making the payment to the current merchant (associated with the payment request at block 403) using the social media-based voice payment process. As a result, the payment application 117 may initiate the voice payment process at block 422 and send a WhatsApp® text message to the customer containing a pre-defied sentence. The message may provide an instruction for the customer to speak and record the pre-defined sentence using the relevant social media application (here, WhatsApp®). As an example, such a message may read: “To approve the transaction, repeat the following phrase with your voice and pressing the WhatsApp microphone icon: ‘I approve the payment with code 3 4 6 7.’ Each number must be pronounced separately, one by one.” As mentioned before, in the pre-defined sentence “I approve the payment with code 3 4 6 7”, the pre-designated command phrase is “I approve the payment” and the variable number is “3 4 6 7” (which may be randomly-generated). It is observed from the earlier discussion that the same pre-designated command phrase was used during the customer's voice registration at block 418 to enable the VPP application 117 to easily ascertain the authenticity of the customer's voice signature as discussed below.

It is noted that, in some embodiments, the variable number mentioned above may act as a Personal Identification Number (PIN) of the customer for the transaction at issue. In particular embodiments, the VPP application 117 may receive the variable number from the card-issuer bank, a PSP, or other entity involved in the processing of the payment transaction. In other embodiments, the VPP application 117 itself may randomly generate the variable number. The VPP application 117 may then generate the pre-defined sentence by appending the variable number to the pre-designated command phrase, and then send the sentence to the customer at block 422. If the customer has multiple cards already enrolled for payments, the customer may select one of those cards for the current payment (block 422). On the other hand, if the customer has only one card registered for payments, the customer may simply choose this card as the “default” payment method. As part of the tasks at block 422, the customer system 104 may generate a WhatsApp® audio message containing the recording of the above-mentioned pre-defined sentence spoken by the customer. Consequently, as noted at block 422, the customer may use WhatsApp® messaging to send to the host system 102 an identification of the card selected by the customer for payment, and the audio message for authenticating the customer's voice signature and the variable number (or random number/issuer PIN).

The payment application 117 may receive the WhatsApp® message(s) sent by the customer at block 422 and perform voice pay authentication of the customer (at block 423) through biometric voice match and STT conversion. The biometric voice match may involve an electronic analysis of the audio message received at block 422. For example, in one embodiment, the VPP application 117 may biometrically analyze the audio message to extract the customer's voice signature therefrom and electronically compare it with the customer's pre-stored voice signature (at block 418) during voice registration process. The voice match may be considered a success if this comparison indicates that both of the signatures are substantially identical. In one embodiment, the technology of voice biometrics from ValidSoft® (https://www.validsoft.com) may be used by the VPP application 117 for such biometric analyses.

It is noted here that each person's throat, paddle and vocal cords are uniquely different, and it is these elements that mainly affect the air that is expelled from a person's lungs and mouth when the person speaks. Starting with the raw audio and the waveform generated when the customer speaks, the VPP application 117 may process the audio waveform to extract key characteristics that are unique to the speaker (here, the customer). From this, a statistical model and voice signature may be built for each individual person enrolled in the voice pay system. When comparing the voice audio later—for example, when authenticating a person against their previously registered voice signature—the same process may be applied a measure of similarity of the key characteristics may be obtained. The value of this measure may indicate whether the voice match is a pass or a fail. Voice biometrics “knows” who the speaker is, but not what the speaker is saying. Therefore, voice biometrics may be used to authenticate the identity of an individual speaker. On the other hand, voice recognition or speech recognition may be used to identify the content of a person's speech—that is, what the person is saying. In some embodiments, both of these technologies may be used together to facilitate voice payments.

In particular embodiments, as part of the authentication at block 423, the payment application 117 also may perform a speech-to-text (STT) conversion on the recording of the pre-defined sentence contained in the audio message (at block 422) to generate texts of the pre-designated command phrase and the variable number spoken by the customer. Thereafter, the payment application 117 may verify that the customer-spoken texts of the pre-designated command phrase and the variable number are correct—that is, the STT converted versions match the corresponding texts in the pre-defined sentence sent by the payment application 117 to the customer as part of the earlier-mentioned WhatsApp® text message at block 422. As mentioned before, the STT conversion may allow the payment application 117 to maintain a record that the customer indeed approved the payment transaction and not any other type of transaction, and used the correct PIN. This record-keeping may assist the merchant or other entity in the event a dispute arises as to whether the payment was authorized or not. In one embodiment, the voice transcription technology from SpeechMatics® (https://www.speechmatics.com) may be used by the VPP application 117 for such STT conversion.

If the voice pay authentication is successful at block 423, the VPP application 117 may proceed with the payment at block 424 in a manner similar to that discussed before with reference to blocks 409-413 in FIG. 4. As a result, the VPP application 117 may execute a transaction with the card-issuer bank to effectuate the payment to the merchant that sent the payment request at block 403. If the payment transaction is successful, the VPP application 117 may inform the customer of the approval number (received from the payment switch or gateway or card-issuer bank) and provide the payment receipt or ticket to the customer in a manner similar to that discussed before with reference to blocks 413-414. In one embodiment, for example, the payment receipt or ticket may identify that the payment was realized with the customer's voice. In that case, the ticket may include a text—such as, for example, “Authorized with Voice”—at the bottom to distinguish the voice payment from other types of payments. Thereafter, the voice payment process of the flowchart 400 may terminate at block 425.

However, if the voice pay authentication is unsuccessful at block 423—for example, if the customer's voice in the audio message at block 422 is not recognized by the biometric verification module 305 (FIG. 3) due to static, poor recording, noise, or any other reason, the VPP application 117 may send a notice to the customer via a WhatsApp® message offering the customer to send his/her voice message again. In one embodiment, the customer may be allowed to repeat their voice authentication attempt a pre-determined number of times—for example, three times. If the customer's attempt fails for the third time (block 426), the VPP application 117 may send a WhatsApp® message to the customer requesting the customer to re-register their card or select another payment method and then make their payment (block 427). If the customer declines to re-register at block 427, the payment process may terminate at block 425. However, if the customer wishes to use another card for payment and/or re-register for voice pay at block 427, the payment application 117 may proceed to transition block 428 (identified by the circled letter “B” in FIG. 4) to initiate re-registration of the customer for voice payment in a manner similar to that discussed earlier with reference to the transition block 406 (identified by the circled letter “A” in FIG. 4). If the customer successfully re-registers for voice payment (through the process at transition block 428), the customer may continue with voice payments in future.

In particular embodiments, as noted before, in addition to the biometric analysis of customer's voice, the VPP application 117 also may verify the customer-spoken variable number (PIN) based on the STT conversion of the audio message received at block 422. Even if the voice signature of the customer is verified at block 423 based on a successful biometric analysis of the pre-designated command phrase spoken by the customer, there may be an error in the random verification number sent by the customer with his/her voice message at block 422. In that case, the VPP application 117 also may send a notice to the customer via a WhatsApp® message offering the customer to send his/her voice message again with a new random number (PIN). As before, if the new PIN-based voice authentication attempt fails for the third time (block 426), the VPP application 117 may send a WhatsApp® message to the customer requesting the customer to re-register their card or select another payment method and then make their payment (block 427). As an example, such a message at block 427 may read: “Your authentication has failed. Would you like to enroll again and to register another payment card?” If the customer declines to re-register at block 427, the payment process may terminate at block 425. However, if the customer wishes to use the same or another card for payment and re-register for voice pay at block 427, the payment application 117 may proceed to transition block 428 (identified by the circled letter “B” in FIG. 4) to initiate re-registration of the customer for voice payment in a manner similar to that discussed earlier with reference to the transition block 406. If the customer successfully re-registers for voice payment (through the process at transition block 428), the customer may continue with voice payments in the future—that is, the next time the customer receives a payment request from the payment application 117 similar to that at block 404.

The foregoing discussion of FIGS. 1-4 illustrates how a customer can use a social media platform to make an online payment using customer's voice in a simple, secure, user-friendly, and trustworthy manner. Once the first payment has been made via the social media application—such as the WhatsApp® messaging application or the Facebook® Messenger application, all payments for subsequent purchases or other transactions can be made with a simple voice command, secured through biometric voice authentication. The customer does not need to share sensitive credit/debit card information every time he/she makes a payment. The system may tokenize and encrypt the card information, and also register the individual cardholder's biometric voice fingerprint that may be used to “unlock” the card token. By doing so, the cardholder is able to make future payments to any affiliated merchant with a simple voice command, as simple as sending a voice message through the social media application. The system allows businesses to send payment requests to their customers by means of messages through social networks and to receive payments safely through a simple voice command spoken by the customer using a smartphone, a tablet, or a personal computer. This saves the customer from receiving multiple, annoying phone calls for payments. The customer may attend to the merchant's messages whenever he/she wishes, and without jeopardizing financial safety.

FIG. 5 illustrates an example configuration of a computer system, such as the host system 102 of FIG. 1, that can be used to implement the voice payment methodology described herein. As discussed before, the computer system (also interchangeably referred to as “computing system” or “computing device”) 102 may be suitably configured to implement the functionality of the payment application 117 according to the teachings of the present disclosure. The computer system 102 may include one or more processors 500, a memory unit 502, an interface unit 504 providing communication interfaces, one or more input devices 506, one or more output devices 508, and a peripheral storage unit 510, connected to the processor 500 as shown and configured to communicate with each other, such as via one or more system buses (not shown) or other suitable connection.

In one embodiment, the input devices 506 may provide operator inputs—such as, for example, messages or commands related to the administration of the host system 102, customer service related inputs (for example, rectifying a credit card number incorrectly entered by the customer), responses to merchant queries, and the like—to the processor 500 and the payment application 117 for further processing. The input devices 506 may include, for example, a touchpad, a camera, a computer keyboard, a touch-screen, a joystick, a physical or virtual “clickable button,” a computer mouse/pointing device, and the like. A display screen is an example of the output device 508. Other examples of an output device include a graphics/display device, a computer screen or monitor, an alarm system, or any other type of data output device. In some embodiments, the input device(s) 506 and the output device(s) 508 may be coupled to the processor 500 via an I/O or peripheral interface(s). In some embodiments, the computer system 102 may include more than one instance of the devices shown. In various embodiments, all of the components shown in FIG. 5 may be housed within a single housing. In other embodiments, the computer system 102 may not include all of the components shown in FIG. 5. Furthermore, the computing system 102 may be configured as a standalone system, as a server system, as a client system (of another server), as a cluster of networked computers, as a virtual machine (e.g., within a cloud computing system), or in any other suitable form factor.

The processor 500 is a hardware device that may include a single processing unit or a number of processing units, all of which may include single or multiple computing units or multiple cores. When the computing device 102 is a multiprocessor system, there may be more than one instance of the processor 500 or there may be multiple other processors coupled to the processor 500 via their respective interfaces (not shown). The processor 500 may include an integrated Graphics Processing Unit (GPU) or the GPU may be a separate processor device in the system 202. The processor 500 may be implemented as one or more microprocessors, microcomputers, microcontrollers, Digital Signal Processors (DSPs), Central Processing Units (CPUs), Graphics Processing Units (GPUs), state machines, logic circuitries, virtual machines, and/or any devices that manipulate signals based on operational instructions. Among other capabilities, the processor 500 may be configured to fetch and execute computer-readable instructions stored in the memory 502, the peripheral storage 510, or other computer-readable media. In some embodiments, the processor 500 may be a System on Chip (SoC).

The memory 502 and the peripheral storage unit 510 are examples of non-transitory computer media (e.g., memory storage devices) for storing instructions that can be executed by the processor 500 to perform the various functions described herein. In some embodiments, the memory 502 and the peripheral storage unit 510 may include tangible, computer-readable data storage media. For example, the memory unit 502 may include both volatile memory and non-volatile memory (e.g., RAM, ROM, or the like) devices. Further, in particular embodiments, the peripheral storage unit 510 may include one or more mass storage devices such as, for example, hard disk drives, solid-state drives, removable media, including external and removable drives, memory cards, flash memory, floppy disks, optical disks (e.g., CD, DVD), a storage array, a network attached storage, a storage area network, or the like. Both memory 502 and mass storage devices constituting the peripheral storage 510 may be collectively referred to as “memory” or “computer storage media” herein, and may be a media capable of storing computer-readable, processor-executable program instructions as computer program code that can be executed by the processor 500 as a particular machine (or special purpose machine) configured for carrying out the operations and functions described in the implementations herein. In some embodiments, the database 118 (FIG. 1) may be a part of such computer storage media. In other embodiments, such computer storage media may be an online cloud-based storage.

The computing device 102 may also include one or more communication interfaces as part of its interface unit 504 for exchanging data via a network (such as the communication network 110 in FIG. 1). The communication interfaces can facilitate communications within a wide variety of networks and protocol types, including wired networks (e.g., Ethernet, Digital Subscriber Loop (DSL), Data Over Cable Service Interface Specification (DOC SIS), Fiber Optics network, Universal Serial Bus (USB), etc.) and wireless networks (e.g., Wireless Local Area Network (WLAN), Global System for Mobile Communications (GSM), Code Division Multiple Access (CDMA), Institute of Electrical and Electronics Engineers (IEEE) standard 802.11, Bluetooth®, Wireless USB, cellular, satellite, etc.), the Internet (or, more generally, the IP network 110), and the like. Communication interfaces in the interface unit 504 can also provide communication with an external storage (not shown in FIG. 5), such as in a storage array, network attached storage, storage area network, one or more databases, or the like. For example, if the database 118 in FIG. 1 is implemented as an external storage, the interface unit 504 may facilitate communication with that database.

The computer storage media, such as the memory 502 and the mass storage devices in the peripheral storage 510, may be used to store software and data. For example, the computer storage media may be used to store the operating system (OS) for the computing device 102, various device drivers for the device 102, various inputs provided by the operator of the device 102 or received from the customer system 104 (for example, audio samples of customer's voice, credit/debit card information, and so on), the merchant system 106 (for example, payment notifications), and the bank system 108 (for example, transaction confirmations or failure notifications, payment receipts, and the like) at run-time during the implementation of the social media-based voice payment methodology discussed before with reference to FIGS. 1-4, and the data such as audio content, video content, text data, streaming content, or any other type of content. The computer storage media also may store software applications such as a word processing application, a spreadsheet application, the payment application 117, and the like. The program code for the software applications and the OS may be executed by the processor 500.

In one embodiment, a non-transitory, computer-readable data storage medium, such as, for example, the system memory 502 or the peripheral data storage unit 510 may store program code or software for the payment application 117 as per particular embodiments of the present disclosure. In the embodiment of FIG. 5, the system memory 502 is shown to include such program code. Such computer-readable data storage medium may be considered an article of manufacture. In the embodiment of FIG. 5, the payment application 117 may operate in conjunction with the OS (not shown) of the computing system 102. The processor 500 may be configured to execute the program code for the payment application 117, whereby the computer system (or computing device) 102 may be operative to perform various voice payment related tasks in a social media environment as per the teachings of the present disclosure. In particular embodiments, such tasks may include, for example, the process steps illustrated in FIG. 2 as well as other relevant tasks discussed with reference to FIGS. 1 and 3-4 such as, for example, reception of a payment notification from the merchant system 106, transmission of payment related social media messages to the customer system 104, reception of credit/debit card payment details from the customer system 104, registration of the customer for voice payments, communication with the bank/PSP system 108 to effectuate payment to the merchant on behalf of the customer, and so on. The program code or software for the payment application 117 may be proprietary software or open source software which, upon execution by the processor 500, may enable the computer system 102 to perform operations related to social media-based voice payments as per teachings of the present disclosure. As a result, the computer system 102 may operate as a special purpose system/device.

In particular embodiments, the computing device 102 may include an on-board power supply unit 512 to provide electrical power to various system components illustrated in FIG. 5. The power supply unit 512 may receive batteries and/or may be connectable to an AC electrical power outlet. In one embodiment, the power supply unit 512 may convert solar energy or other renewable energy into electrical power.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability, and, hence, are considered machine-implemented. Generally, any of the functions described with reference to the figures can be implemented using software, hardware (e.g., fixed logic circuitry) or a combination of these implementations. The terms “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions), such as the program code for the payment application 117 (including the software modules shown in FIG. 3), that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although the present disclosure has been described in connection with several embodiments, the disclosure is not intended to be limited to the specific forms set forth herein. On the contrary, it is intended to cover such alternatives, modifications, and equivalents as can be reasonably included within the scope of the disclosure as defined by the appended claims.

What is claimed is:

1. A method comprising:
receiving, by a computing system, a first payment notification from a first merchant requesting a first payment from a customer, wherein the first payment notification identifies the customer and a first phone number registered for the customer with a social media messaging application;
sending, by the computing system, the first payment notification to the first phone number of the customer as a first text message having a format required by the social media application, wherein the first text message offers the customer an option to pay the first merchant electronically via the social media application;
determining, by the computing system, that the customer is registered for voice payment and has selected the option to pay the first merchant;
sending, by the computing system, a second text message to the customer in the format required by the social media application, wherein the second text message contains a first pre-defined sentence;
instructing, by the computing system, the customer to speak and record the first pre-defined sentence using the social media application;
receiving, by the computing system, the following from the customer via the social media application:
an identification of a means of payment selected by the customer to electronically pay the first merchant, and
an audio message containing a recording of the first pre-defined sentence spoken by the customer;
authenticating, by the computing system, a first voice signature of the customer based on an electronic analysis of the audio message; and
executing, by the computing system, a transaction with an entity that has issued the customer-selected means of payment to effectuate the first payment to the first merchant.

2. The method of claim 1, wherein receiving the first payment notification comprises at least one of the following:
receiving, by the computing system, the first payment notification from a second phone number registered for the first merchant with the social media application; and
receiving, by the computing system, the first payment notification as a third text message having the format required by the social media application.

3. The method of claim 1, wherein sending the first payment notification comprises:
sending, by the computing system, the following as part of the first text message:
a second phone number registered for the first merchant with the social media application.

4. The method of claim 1, wherein the social media application is one of the following:
a WhatsApp® messaging application; and
a Facebook® Messenger application.

5. The method of claim 1, wherein the first pre-defined sentence includes the following:
a pre-designated command phrase; and
a variable number as a personal identification number (PIN) of the customer.

6. The method of claim 5, further comprising:
performing, by the computing system, one of the following:
receiving the variable number from the entity that has issued the customer-selected means of payment, and
generating the variable number for the first pre-defined sentence; and
generating, by the computing system, the first pre-defined sentence by appending the variable number to the pre-designated command phrase.

7. The method of claim 5, further comprising:
sending, by the computing system, a third text message to the customer in the format required by the social media application, wherein the third text message is sent prior to the second text message and contains a secure link to enable the customer to electronically make a second payment to a second merchant via the social media application, wherein the second payment is made prior to the first payment, and wherein the secure link allows the customer to provide details of the customer-selected means of payment for verification with the entity that has issued the customer-selected means of payment;
receiving, by the computing system, the details of the customer-selected means of payment via the social media application;
transmitting, by the computing system, the details of the customer-selected means of payment and an amount of the second payment to the entity for processing;
receiving, by the computing system, an indication from the entity that the second payment is successfully processed using the customer-selected means of payment;
sending, by the computing system, a fourth text message to the customer in the format required by the social media application, wherein the fourth text message invites the customer to register the means of payment and a second voice signature of the customer for future transactions;
receiving, by the computing system, an affirmative response to the fourth text message from the customer via the social media application;
securely storing, by the computing system, the details of the customer-selected means of payment for future use by the customer; and
registering, by the computing system, the customer for voice payment upon successful storage of the second voice signature of the customer based on a pre-determined number of recordings of a second pre-defined sentence received from the customer via the social media application.

8. The method of claim 7, wherein one of the following applies:
the second merchant is different from the first merchant, and
the second merchant and the first merchant are the same; and
wherein sending the third text message comprises:
receiving, by the computing system, a second payment notification from the second merchant requesting the second payment from the customer, wherein the second payment notification identifies the customer and the first phone number registered for the customer with the social media messaging application;
sending, by the computing system, the second payment notification to the first phone number of the customer as a fifth text message having the format required by the social media application, wherein the fifth text message offers the customer the option to pay the second merchant electronically via the social media application;
determining, by the computing system, that the customer is yet to be registered for voice payment; and
sending, by the computing system, the third text message to the customer as part of initiating registration of the customer for voice payment.

9. The method of claim 7, wherein registering the customer for voice payment comprises:
sending, by the computing system, a pre-determined number of recording-related text messages to the customer in the format required by the social media application, wherein each text message in the pre-determined number of recording-related text messages invites the customer to speak the second pre-defined sentence and send a recording thereof via the social media application, thereby generating the pre-determined number of recordings of the second pre-defined sentence;
receiving, by the computing system, the pre-determined number of recordings from the customer via the social media application;
biometrically analyzing, by the computing system, the pre-determined number of recordings to extract the second voice signature of the customer therefrom;
determining, by the computing system, that the second voice signature of the customer is successfully extracted from the pre-determined number of recordings; and
storing, by the computing system, the second voice signature of the customer for future voice payments by the customer.

10. The method of claim 7, wherein authenticating the first voice signature of the customer comprises:
biometrically analyzing, by the computing system, the audio message to extract the first voice signature therefrom;
electronically comparing, by the computing system, the first and the second voice signatures; and
based on the electronic comparison, determining, by the computing system, that the first and the second voice signatures are substantially identical.

11. The method of claim 5, further comprising:
performing, by the computing system, a speech-to-text conversion on the recording of the first pre-defined sentence contained in the audio message to generate texts of the pre-designated command phrase and the variable number spoken by the customer; and
verifying, by the computing system, that the customer-spoken texts of the pre-designated command phrase and the variable number are correct.

12. The method of claim 1, further comprising:
receiving, by the computing system, an approval of the transaction from the entity; and
sending, by the computing system, a third text message to the customer in the format required by the social media application, wherein the third text message contains a receipt of the first payment.

13. A method comprising:
receiving, by a computing system, a first payment notification from a merchant requesting a first payment from a customer, wherein the first payment notification identifies the customer and a phone number registered for the customer with a social media messaging application;
sending, by the computing system, the first payment notification to the phone number of the customer as a first text message having a format required by the social media application, wherein the first text message offers the customer an option to pay the merchant electronically via the social media application;
determining, by the computing system, that the customer has selected the option to pay the merchant;
sending, by the computing system, a second text message to the customer in the format required by the social media application, wherein the second text message contains a secure link to enable the customer to electronically make the first payment to the merchant via the social media application, wherein the secure link allows the customer to provide details of a customer-selected means of payment for verification with an entity that has issued the customer-selected means of payment;
receiving, by the computing system, the details of the customer-selected means of payment via the social media application;
transmitting, by the computing system, the details of the customer-selected means of payment and an amount of the first payment to the entity for processing;
receiving, by the computing system, an indication from the entity that the first payment is successfully processed using the customer-selected means of payment;
sending, by the computing system, a third text message to the customer in the format required by the social media application, wherein the third text message invites the customer to register the means of payment and a voice signature of the customer for future transactions;
receiving, by the computing system, an affirmative response to the third text message from the customer via the social media application;
securely storing, by the computing system, the details of the customer-selected means of payment for future use by the customer; and
registering, by the computing system, the customer for voice payment upon successful storage of the voice signature of the customer based on a pre-determined number of recordings of a first pre-defined sentence received from the customer via the social media application, wherein the first pre-defined sentence is formed of a pre-designated command phrase and a first variable number.

14. The method of claim 13, further comprising:
receiving, by the computing system, a second payment notification from the merchant requesting a second payment from the customer, wherein the second payment notification identifies the customer and the phone number registered for the customer with the social media messaging application;
sending, by the computing system, the second payment notification to the phone number of the customer as a fourth text message having the format required by the social media application, wherein the fourth text message offers the customer the option to pay the merchant electronically via the social media application;
determining, by the computing system, that the customer is registered for voice payment and has selected the option to pay the merchant;
sending, by the computing system, a fifth text message to the customer in the format required by the social media application, wherein the fifth text message contains a second pre-defined sentence formed of the pre-designated command phrase and a second variable number;
instructing, by the computing system, the customer to speak and record the second pre-defined sentence using the social media application;
receiving, by the computing system, the following from the customer via the social media application:
an identification of the customer-selected means of payment, and
an audio message containing a recording of the second pre-defined sentence spoken by the customer;
authenticating, by the computing system, the voice signature of the customer based on an electronic analysis of the audio message; and
executing, by the computing system, a transaction with the entity to effectuate the second payment to the merchant.

15. The method of claim 13, wherein registering the customer for voice payment comprises:
sending, by the computing system, a pre-determined number of recording-related text messages to the customer in the format required by the social media application, wherein each text message in the pre-determined number of recording-related text messages invites the customer to speak the first pre-defined sentence and send a recording thereof via the social media application, thereby generating the pre-determined number of recordings of the first pre-defined sentence;
receiving, by the computing system, the pre-determined number of recordings from the customer via the social media application;
biometrically analyzing, by the computing system, the pre-determined number of recordings to extract the voice signature of the customer therefrom;
determining, by the computing system, that the voice signature of the customer is successfully extracted from the pre-determined number of recordings; and
storing, by the computing system, the voice signature of the customer for future voice payments by the customer.

16. The method of claim 13, wherein the social media application is one of the following:
a WhatsApp® messaging application; and
a Facebook® Messenger application.

17. A computer program product comprising a non-transitory computer-usable medium having computer-readable program code embodied therein, wherein the computer-readable program code, when executed by a computing system, causes the computing system to implement a method comprising:
sending a first payment notification from a first merchant to a customer of the first merchant via a first text message having a format required by a social media messaging application, wherein the social media application is one of the following:
a WhatsApp® messaging application, and
a Facebook® Messenger application;
offering the customer a choice to pay the first merchant via the social media application using customer's voice along with a customer-selected means of payment; and
processing a first voice signature of the customer and the customer-selected means of payment to effectuate the first payment to the first merchant.

18. The computer program product of claim 17, wherein the method further comprises:
receiving the first payment notification from the first merchant requesting the first payment from the customer, wherein the first payment notification identifies the customer and a phone number registered for the customer with the social media application;
sending the first payment notification to the phone number of the customer as the first text message, wherein the first text message offers the customer an option to pay the first merchant electronically via the social media application;
determining that the customer is registered for voice payment and has selected the option to pay the first merchant;
sending a second text message to the customer in the format required by the social media application, wherein the second text message contains a first pre-defined sentence formed of a pre-designated command phrase followed by a first variable number;
instructing the customer to speak and record the first pre-defined sentence using the social media application;
receiving the following from the customer via the social media application:
an identification of the customer-selected means of payment to electronically pay the first merchant, and
an audio message containing a recording of the first pre-defined sentence spoken by the customer;
authenticating the first voice signature of the customer based on an electronic analysis of the audio message; and
executing a transaction with an entity that has issued the customer-selected means of payment to effectuate the first payment to the first merchant.

19. The computer program product of claim 18, wherein the method further comprises:
receiving a second payment notification from a second merchant requesting a second payment from the customer, wherein the second payment notification identifies the customer and the phone number registered for the customer with the social media messaging application;
sending the second payment notification to the phone number of the customer as a third text message having the format required by the social media application wherein the third text message offers the customer the option to pay the second merchant electronically via the social media application;
determining that the customer is yet to be registered for voice payment;
sending a fourth text message to the customer in the format required by the social media application, wherein the fourth text message is sent prior to the second text message and contains a secure link to enable the customer to electronically make the second payment to the second merchant via the social media application, wherein the second payment is made prior to the first payment, and wherein the secure link allows the customer to provide details of the customer-selected means of payment for verification with the entity that has issued the customer-selected means of payment;
receiving the details of the customer-selected means of payment via the social media application;
transmitting the details of the customer-selected means of payment and an amount of the second payment to the entity for processing;
receiving an indication from the entity that the second payment is successfully processed using the customer-selected means of payment;
sending a fifth text message to the customer in the format required by the social media application, wherein the fifth text message invites the customer to register the means of payment and a second voice signature of the customer for future transactions;
receiving an affirmative response to the fifth text message from the customer via the social media application;
securely storing the details of the customer-selected means of payment for future use by the customer;
sending a pre-determined number of recording-related text messages to the customer in the format required by the social media application, wherein each text message in the pre-determined number of recording-related text messages invites the customer to speak a second pre-defined sentence and send a recording thereof via the social media application, thereby generating a pre-determined number of recordings of the second pre-defined sentence, wherein the second pre-defined sentence is formed of the pre-designated command phrase followed by a second variable number;
receiving the pre-determined number of recordings from the customer via the social media application;
biometrically analyzing the pre-determined number of recordings to extract the second voice signature of the customer therefrom;
determining that the second voice signature of the customer is successfully extracted from the pre-determined number of recordings; and
storing the second voice signature of the customer for future voice payments by the customer.

20. The computer program product of claim 19, wherein one of the following applies:
the second merchant is different from the first merchant, and
the second merchant and the first merchant are the same; and
wherein authenticating the first voice signature of the customer comprises:
biometrically analyzing the audio message to extract the first voice signature therefrom;
electronically comparing the first and the second voice signatures; and
based on the electronic comparison, determining that the first and the second voice signatures are substantially identical.

21. The computer program product of claim 17, wherein the first merchant is affiliated with a payment processing entity; wherein the payment processing entity is one of the following: a bank that has issued the customer-selected means of payment, and a Payment Service Provider (PSP); and wherein the method further comprises:
enrolling the customer for voice payment via a personal banking app associated with the payment processing entity, thereby allowing the customer to pay the first merchant using the customer's voice.
